(19) United States
(12) Patent Application Publication
(10) Pub. No.: US 2025/0001908 A1
(43) Pub. Date: Jan. 2, 2025

(54) VEHICLE LOWER STRUCTURE AND VEHICLE SEAT STRUCTURE OF ELECTRICALLY-POWERED VEHICLE

(71) Applicant: TOYOTA JIDOSHA KABUSHIKI KAISHA, Aichi-ken (JP)

(72) Inventor: Shinsuke OMORI, Toyota-shi (JP)

(21) Appl. No.: 18/747,442

(22) Filed: Jun. 19, 2024

(30) Foreign Application Priority Data
Jun. 30, 2023 (JP) 2023-108904

(51) Int. Cl. B60N 2/07

(52) U.S. Cl. CPC B60N 2/07

(57) ABSTRACT

A vehicle lower structure of an electrically-powered vehicle, the structure including: a drive battery pack installed at a vehicle lower side of a floor of the vehicle; and at least one seat rail configured engageably with a slide member provided at a vehicle seat, the seat rail being provided at the vehicle lower side of the floor, and at a wall portion in a vehicle width direction of the drive battery pack or at a position opposing the wall portion.

### CROSS-REFERENCE TO RELATED APPLICATION

This application is based on and claims priority under 35 USC 119 from Japanese Patent Application No. 2023-108904 filed on Jun. 30, 2023, the disclosure of which is incorporated by reference herein.

### BACKGROUND

### Technical Field

The present disclosure relates to a vehicle lower structure and a vehicle seat structure of an electrically-powered vehicle.

### Related Art

Japanese Patent Application Laid-Open (JP-A) No. H6-219336 discloses an electrically-powered vehicle in which a drive battery is installed below a floor.

In the electrically-powered vehicle described in JP-A No. H6-219336, since a battery is present, a seat rail is provided on the floor corresponding to the upper position of the battery, and there is room for improvement of the accommodation space in the vehicle height direction of an occupant.

### SUMMARY

The present disclosure provides a vehicle lower structure and a vehicle seat structure of an electrically-powered vehicle that are capable of enlarging an accommodation space in a vehicle height direction of an occupant, compared to cases in which a seat rail is disposed on a floor inside a vehicle cabin.

A vehicle lower structure of an electrically-powered vehicle of a first aspect of the present disclosure includes: a drive battery pack installed at a vehicle lower side of a floor of the vehicle; and at least one seat rail configured engageably with a slide member provided at a vehicle seat, the seat rail being provided at the vehicle lower side of the floor, and at a wall portion in a vehicle width direction of the drive battery pack or at a position opposing the wall portion.

In the vehicle lower structure of the electrically-powered vehicle of the first aspect of the present disclosure, at least one seat rail is engageable with a slide member provided at a vehicle seat, and is provided at the vehicle lower side of the vehicle floor, and at a wall portion in the vehicle width direction of the drive battery pack or at a position opposing the wall portion. Since, as a result, the installation position of the vehicle seat can be lowered compared to cases in which the seat rail is disposed on the vehicle floor, the occupant's accommodation space in the vehicle height direction can be expanded.

A vehicle lower structure of an electrically-powered vehicle of a second aspect of the present disclosure has the configuration of the first aspect, including a rocker provided at each of respective end parts in a vehicle width direction of the vehicle, and along a vehicle front-rear direction, in which the seat rail is provided at an outer side in a vehicle width direction of the vehicle seat, and is disposed at an outer side of the wall portion of the drive battery pack and at an upper face of the rocker.

In the vehicle lower structure of the electrically-powered vehicle of the second aspect of the present disclosure, a seat rail provided at the vehicle width direction outer side is provided at the outer side of a wall portion of the drive battery pack, and is provided at the upper face of the rocker. As a result, owing to the seat rail being provided at the outer side of the wall portion of the drive battery pack, insulation with respect to the drive battery can be easily secured. Further, because the seat rail is provided at the upper face of the rocker, a space closer to the rocker than the drive battery pack can be utilized both as a space in which load transmission to the drive battery is suppressed, and as a space in which the seat rail is disposed.

A vehicle lower structure of an electrically-powered vehicle of a third aspect of the present disclosure has the configuration of the first aspect, in which the seat rail is provided at an outer side in a vehicle width direction of the vehicle seat, and is disposed at an inner side of the wall portion of the drive battery pack.

In the vehicle lower structure of the electrically-powered vehicle of the third aspect of the present disclosure, the seat rail is provided at the vehicle width direction outer side of the vehicle seat, and is provided at an inner side of the wall portion of the drive battery pack. Since, as a result, there is no need to newly provide a space for arranging the seat rail at the outer side of the drive battery pack, an increase in the arrangement space in the vehicle width direction can be suppressed.

A vehicle seat structure of a fourth aspect of the present disclosure includes: the vehicle lower structure of any one of the first aspect to the third aspect; a seat cushion configured to seat an occupant; a pair of seat leg portions extending towards a vehicle lower side at respective vehicle width direction sides of the seat cushion, and disposed overlapping with side faces of the floor of the vehicle; and a slide member provided at at least one seat leg portion corresponding to the seat rail among the pair of seat leg portions, and being configured to move along the seat rail.

In the vehicle seat structure of the fourth aspect of the present disclosure, a pair of seat leg portions extend toward the vehicle lower side at respective vehicle width direction sides of the seat cushion, and are disposed overlapping with side faces of the vehicle floor. Since, as a result, a space corresponding to the height of the pair of seat legs can be provided between the pair of seat leg portions on the vehicle floor, it is possible, for example, to enlarge an accommodation space at the feet of an occupant seated in a vehicle seat at the rear side of the vehicle seat.

A vehicle seat structure of a fifth aspect of the present disclosure has the configuration of the fourth aspect, in which the at least one seat leg portion is provided with the slide member at a side of a face opposing the other seat leg portion.

In the vehicle seat structure of the fifth aspect of the present disclosure, since the at least one seat leg portion is provided with the slide member at a side of a face side opposing the other seat leg portion, the slide member can be prevented from being exposed from the seat leg portion, which enables the appearance to be improved.

As explained above, the vehicle lower structure and the vehicle seat structure of the electrically-powered vehicle according to the present disclosure have the excellent advantageous effect of enabling the occupant's accommodation space in the vehicle height direction to be enlarged, compared to cases in which the seat rail is disposed on the floor inside the vehicle cabin.

### BRIEF DESCRIPTION OF THE DRAWINGS

Exemplary embodiments of the present disclosure will be described in detail based on the following figures, wherein:

FIG. 1 is a perspective view, from an obliquely left direction, of a vehicle lower portion to which a vehicle lower structure according to one embodiment of the present disclosure is applied;

FIG. 2 is a left side view of the vehicle lower portion of FIG. 1;

FIG. 3 is a cross-section taken along line A-A in FIG. 1;

FIG. 4 is a cross-section of a modified example corresponding to FIG. 3; and

FIG. 5 is a cross-section view illustrating another modified example corresponding to FIG. 3.

### DETAILED DESCRIPTION

Explanation follows regarding a vehicle lower structure according to one embodiment of the present disclosure, based on the drawings. Note that in each of the drawings, as appropriate, the arrow FR, the arrow UP, and the arrow LH respectively indicate the front direction, upper direction, and left direction of a vehicle to which a vehicle lower structure according to one embodiment of the present disclosure is applied. Unless specifically stated otherwise, simple reference to the front and rear, up and down, and left and right directions refers to front and rear in the vehicle front-rear direction, up and down in the vehicle vertical direction, and left and right when facing the front direction.

A vehicle to which the vehicle lower structure 10 of the present exemplary embodiment is applied is for example, an electric automobile, gasoline hybrid vehicle, or fuel cell hybrid vehicle that runs with an electric motor (motor), not illustrated in the drawings, as a drive source, and a drive battery pack 20 that stores electric power for supply to an electric motor is disposed below a vehicle lower side of a floor panel 12 configuring a floor of a vehicle.

### Configuration of Vehicle Lower Structure

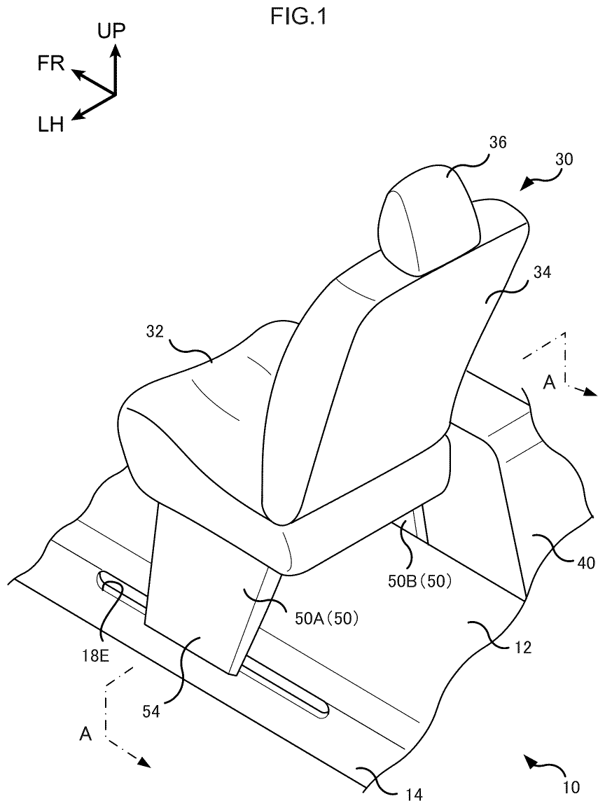

As illustrated in FIGS. 1 to 3, a floor panel 12 extends along a vehicle width direction and a vehicle front-rear direction at a vehicle lower portion to which the vehicle lower structure 10 according to the present exemplary embodiment is applied. In the present exemplary embodiment, the floor panel 12 configures a floor serving as a floor surface of a vehicle. Further, rockers 14 respectively extend along the vehicle front-rear direction at both vehicle width direction ends of the floor panel 12. Note that in each of the drawings, only the rocker 14 at the vehicle width direction left side is illustrated, and illustration of the rocker 14 at the right side is omitted. Explanation follows regarding the left rocker 14 in the vehicle width direction, and explanation of the right rocker 14 is omitted here because the configuration of the right rocker 14 is the same as that of the left rocker 14.

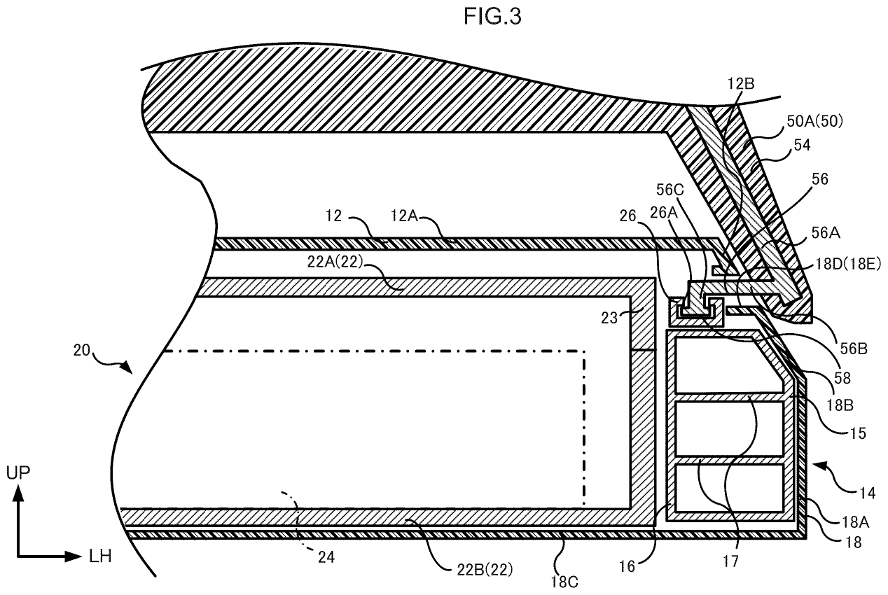

The rocker 14 is a skeleton member configuring a skeleton of a vehicle body lower portion at a vehicle body side portion, and extends in the vehicle front-rear direction. As illustrated in FIG. 3, the rocker 14 is configured including an outer portion 15 disposed at a vehicle width direction outer side, an inner portion 16 disposed at a vehicle width direction inner side, and a rocker reinforcement 17 disposed between the outer portion 15 and the inner portion 16. The outer portion 15 and the inner portion 16 are reinforced by the rocker reinforcement 17. Note that in FIG. 3, the rocker 14 is schematically illustrated. The rocker 14 is formed of a metal such as an aluminum alloy, for example, and the outer portion 15, the inner portion 16, and the rocker reinforcement 17 are joined together by welding or the like. Note that the rocker 14 may be formed by integrally forming the outer portion 15, the inner portion 16, and the rocker reinforcement 17 by casting, extrusion, drawing, or the like.

As illustrated in FIG. 3, in the present exemplary embodiment, the vehicle outer side face of the rocker 14 is covered by a rocker molding 18, which is a design component made of resin or the like. The rocker molding 18 is provided with a cover portion 18A formed along the vertical direction in a cross-section shape cut along the vehicle width direction. The rocker molding 18 is provided, at the vehicle upper side of the cover portion 18A, with an upper cover portion 18B that inclines upward toward the vehicle width direction inner side. The rocker molding 18 is provided with a lower cover portion 18C that extends toward the vehicle width direction inner side. The upper cover portion 18B includes, at an upper end, at one portion in the vehicle front-rear direction, an upper end portion 18D that is bent at a substantial right angle toward an inner side in the vehicle width direction, and a cover insertion hole 18E through which a leg frame 56, described later, is inserted is formed by the upper end portion 18D.

The floor panel 12 includes a flat portion 12A formed in a flat shape, and oblique side portions 12B that extend obliquely outward from both ends of the flat portion 12A toward the lower side. The oblique side portion 12B is formed such that it inclines at the same angle as the upper cover portion 18B when the floor panel 12 is mounted at the rocker molding 18.

The cover insertion hole 18E is formed extending along the vehicle front-rear direction, and in the present exemplary embodiment, after the leg frame 56, described later, has been inserted through the cover insertion hole 18E, the floor panel 12 and the rocker molding 18 are coupled together by bolts or the like. Note that, as illustrated in FIG. 1, the floor panel 12 and the rocker molding 18 are fixed at positions in which the cover insertion hole 18E is not formed. Further, FIG. 3 is schematically illustrated. For example, in FIG. 3, the rocker 14 and the rocker molding 18 are illustrated separately from each other; however, actually, the rocker molding 18 is fixed in contact with the rocker 14.

Returning to FIG. 1, a vehicle seat 30 is disposed on the upper face of the floor panel 12. Note that in each of the drawings, only the front vehicle seat 30 installed at the left side in the vehicle width direction is illustrated; however, actually, the vehicle seat 30 at the front side is also disposed at the right side in the vehicle width direction. Further, a rear side vehicle seat (not illustrated), such as a bench seat, for example, is disposed at the rear side of the front side vehicle seat 30. Note that the rear side vehicle seat may be provided only in a second row, or may be provided in second and third rows. The rear side vehicle seat is not limited to a bench seat, and a seat of a known structure can be installed.

As illustrated in FIG. 1, a center console 40 is provided between the left and right front vehicle seats 30 on the upper face of the floor panel 12. The center console 40 is provided continuously with a vehicle width direction center portion of an instrument panel (not illustrated in the drawings), and respective end portions in the vehicle width direction are provided so as to be positioned at respective sides of the vehicle seat 30 at the left side and the vehicle seat 30 at the right side. Although not illustrated in the drawings, on the upper face of the center console 40, as an example, a cup holder, or an operation portion that is capable of operating vehicle electronic devices, such as a car navigation device or an acoustic device, may be provided, and a console box may be provided. In cases in which a console box is provided, an armrest extending in the vehicle front-rear direction may be disposed above the console box so as to cover the upper portion thereof. In such cases, a rear end portion or a side end portion of the armrest is provided so as to be rotatable with respect to the console box, and the armrest functions as a lid body that opens and closes the console box.

As illustrated in FIG. 3, a drive battery pack 20, serving as a drive force supply device for supplying electric power to a power unit such as a motor, is disposed at a vehicle lower side of the floor panel 12. The drive battery pack 20 is configured including a battery pack case 22 configuring an outer shell thereof, and a battery 24 disposed inside the battery pack case 22.

The battery pack case 22 includes a battery upper case 22A that covers the battery 24 from the vehicle upper side, and a battery lower case 22B that covers the battery 24 from the vehicle lower side, and the battery 24 is housed inside the battery pack case 22 such that it is covered from the vehicle upper and lower directions by the battery upper case 22A and the battery lower case 22B. The battery pack case 22 extends in the vehicle width direction between the vehicle width direction left and right rockers 14, and is disposed below the left and right vehicle seats 30 at the vehicle front side. Further, the battery pack case 22 extends in the vehicle front-rear direction including at least the left and right vehicle seats 30 at the vehicle front side.

As an example, the battery upper case 22A is made of a light metal or a steel plate, and the battery lower case 22B is made of a steel plate, for example. Seat rails 26, each having a substantially elongate shape with a length direction along the vehicle front-rear direction, are provided at the outer side of the wall portions 23 at both vehicle width direction sides of the battery upper case 22A, and at the side of the rocker 14, and as an example, the seat rail 26 is fastened to the upper surface of the rocker 14 by a bolt or the like. Note that the seat rail 26 may be integrally formed with the rocker 14. The seat rail 26 is configured such that a slide member 58, described later, of the vehicle seat 30 can be engaged with the seat rail 26. As an example, the seat rail 26 includes a lower face portion extending substantially horizontally in longitudinal sectional view, and side wall portions extending upward from both vehicle width direction end portions of the lower face portion toward a vehicle upper side, and has a substantially C-shaped open cross-section that is open toward the vehicle upper side. Namely, the vehicle upper side is open, and a concave portion 26A extending in the vehicle front-rear direction is provided.

The battery 24 is configured including plural battery pack modules, not illustrated in the drawings. The battery module is configured, for example, from a battery stack formed by stacking a large number of battery cells, a metal case housing the battery stack, various electric components disposed above the battery stack, and the like. The battery cell is a rechargeable/dischargeable secondary battery, such as a lithium ion secondary battery. The metal case is made of a light metal such as aluminum, for example.

The battery modules (not illustrated in the drawings) are installed side-by-side in one direction at a given spacing above the battery lower case 22B. The battery upper case 22A covers the upper surface of the battery modules arranged above the battery lower case 22B. Note that an upper cross member (not illustrated) configuring a vehicle skeleton is attached to an upper face of the battery upper case 22A, and a lower cross member (not illustrated) configuring a vehicle skeleton is attached to a lower face of the battery lower case 22B.

As an example, the battery lower case 22B is fastened to the rocker 14 by a bolt or the like via an impact absorption portion (not illustrated). In cases in which an impact absorption structure is provided inside the rocker 14, the battery lower case 22B is fastened to the rocker 14 by a bolt or the like. Note that as the impact absorption portion and the impact absorption structure, a known structure formed in a ladder shape in cross-section or the like can be used, for example.

### Configuration of Vehicle Seat Structure

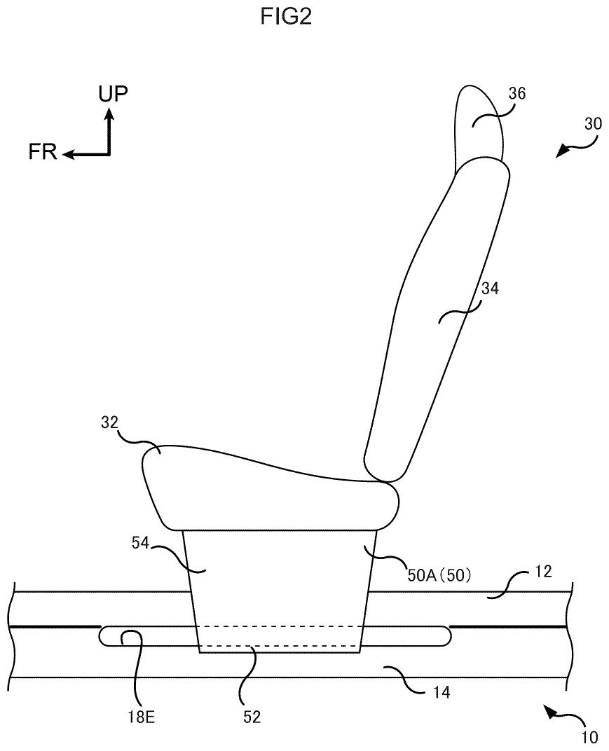

As illustrated in FIGS. 1 and 2, a vehicle seat 30 according to the present exemplary embodiment is provided with a seat cushion 32 for seating an occupant (supporting the buttocks and thighs of the occupant), a seatback 34 that supports the back of the occupant—that is, configures a backrest—and a headrest 36 that supports the head of the occupant. The seatback 34 stands erect from a vehicle rear end portion of the seat cushion 32, and includes a reclining function, being rotatable with respect to the seat cushion 32. Note that since known techniques can be used as the reclining function, detailed explanation thereof is omitted here.

The vehicle seat 30 is provided with a pair of seat leg portions 50. The pair of seat leg portions 50 each include an outer seat leg portion 50A at the vehicle width direction outer side, and an inner seat leg portion 50B at the inner side. The outer seat leg portion 50A and the inner seat leg portion 50B extend toward the vehicle lower side at both vehicle width direction sides of the seat cushion 32, and as illustrated in FIG. 2, they are disposed overlapping with the side surfaces of the floor panel 12. Specifically, as illustrated in FIG. 2, the outer seat leg portion 50A and the inner seat leg portion 50B are disposed such that the lower end portion 52 in the vehicle lower direction covers the cover insertion hole 18E provided in the above-described rocker molding 18. Note that in the present exemplary embodiment, as an example, the floor panel 12 has openings (not illustrated) extending in the vehicle front-rear direction at the side portions of the center console 40, and the inner seat leg portions 50B are disposed overlapping with the side surfaces forming the openings of the floor panel 12 by being inserted into these openings.

As illustrated in FIG. 3, the pair of seat leg portions 50 (the outer seat leg portions 50A) each include a leg molding 54, which is a design component made of resin or the like, that covers the outside surfaces of the respective seat leg portions 50. A lower end of the vehicle lower side of the leg molding 54 that covers the outer seat leg portion 50A is positioned so as to cover the cover insertion hole 18E of the above-described rocker molding 18. in other words, as illustrated in FIGS. 1 and 2, the cover insertion hole 18E is formed so as to be visible from the vehicle outer side at positions at which the leg molding 54 is not positioned.

The outer seat leg portion 50A is connected to the vehicle width direction outer sides of a seat pan (not illustrated in the drawings) configuring the skeleton of the seat cushion 32, and includes a leg frame 56 configuring the skeleton of the outer seat leg portion 50A. The leg frame 56 includes an upper frame 56A, made of stainless steel as one example, and extending from a lower end of the seat pan toward the vehicle lower side, an intermediate frame 56B extending toward the vehicle width direction inner side from a lower end portion of the upper frame 56A, and a lower frame 56C extending downward from an end portion of the intermediate frame 56B.

A slide member 58 that engages with the concave portion 26A of the seat rail 26 described above is provided at a lower end of the lower frame 56C of the outer seat leg portion 50A. Namely, the slide member 58 provided at the outer seat leg portion 50A is provided at a face corresponding to the inner seat leg portion 50B, with the intermediate frame 56B and the lower frame 56C interposed therebetween.

The slide member 58 extends along the vehicle front-rear direction, and is shorter than the concave portion 26A of the seat rail 26. As an example, the slide member 58 is configured to be capable of sliding with respect to the seat rail 26 upon provision of a ball bearing or the like between the slide member 58 and the seat rail 26. Namely, the slide member 58 moves along the seat rail 26. Note that known techniques can be used for the slidable structure, and detailed explanation thereof is omitted here.

The inner seat leg portion 50B is connected to the vehicle width direction inner side of a seat pan (not illustrated) configuring the skeleton of the seat cushion 32, and includes a leg frame configuring the skeleton of the inner seat leg portion 50B. The leg frame is made, for example, of stainless steel, extends from a lower end of the seat pan toward a vehicle lower side, and has a slide member 58 is provided at a lower end thereof. Note that in the present exemplary embodiment, an exemplary seat rail including the concave portion 26A that is engaged with the slide member 58 at the inside seat leg portion 50B side is not illustrated in the drawings; however, the battery upper case 22A is provided at the vehicle lower end of the opening of the floor panel 12 described above.

### Mechanism and Effects of Vehicle Lower Structure

Explanation follows regarding the mechanism and advantageous effects of the vehicle lower structure 10 and the vehicle seat 30 structure according to the present exemplary embodiment.

In the vehicle lower structure 10 of the electrically-powered vehicle according to the present exemplary embodiment, the seat rail 26 at the vehicle width direction outer side is engageable with the slide member 58 installed in the vehicle seat 30, and is provided below the vehicle floor panel 12 of the vehicle, and is provided at a position facing the wall portion 23 in the vehicle width direction of the drive battery pack 20. This enables the installation position of the vehicle seat 30 to be lowered compared to cases in which the seat rail 26 is disposed on the vehicle floor panel 12, and therefore, the occupant's accommodation space in the vehicle height direction can be expanded.

Further, in the vehicle lower structure 10 of the electrically-powered vehicle according to the present exemplary embodiment, the seat rail 26 provided at the vehicle width direction outer side is provided at an outer side of the wall portion 23 of the drive battery pack 20, and at the side of the rocker 14. As a result, the seat rail 26 is provided at the outer side of the wall portion 23 of the drive battery pack 20, thereby enabling insulation relative to the battery 24 to be easily secured. Further, because the seat rail 26 is provided on an upper face of the rocker 14, a space closer to the rocker 14 than the drive battery pack 20 can be utilized both as a space that suppresses load transmission to the battery 24, and as a space in which the seat rail 26 is disposed.

Further, in the structure of the vehicle seat 30 according to the present exemplary embodiment, a pair of seat leg portions 50 extend toward the vehicle lower side at both vehicle width direction sides of the seat cushion 32, and are installed overlapping with side surfaces of the vehicle floor panel 12. As a result, since a space corresponding to the height of the pair of seat legs 50 can be provided between the pair of seat legs 50 on the vehicle floor panel 12, it is possible, for example, to enlarge an accommodation space at the feet of an occupant seated in a vehicle seat at the rear side of the vehicle seat 30.

Further, in the structure of the vehicle seat 30 according to the present exemplary embodiment, since the slide member 58 is provided at the surface side of the outer seat leg portion 50A facing the inner seat leg portion 50B, the slide member 58 can be prevented from being exposed from the outer seat leg portion 50A. This enables the appearance to be improved.

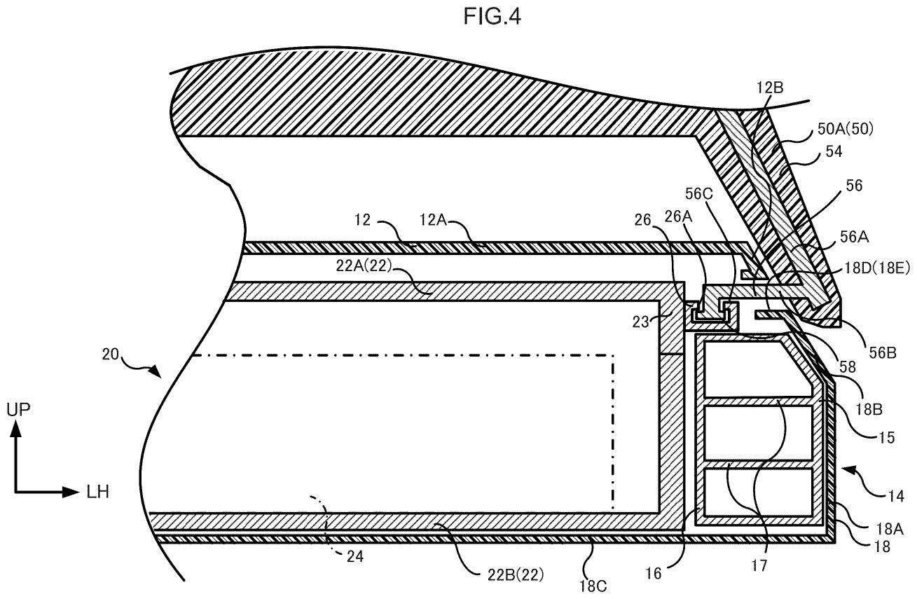

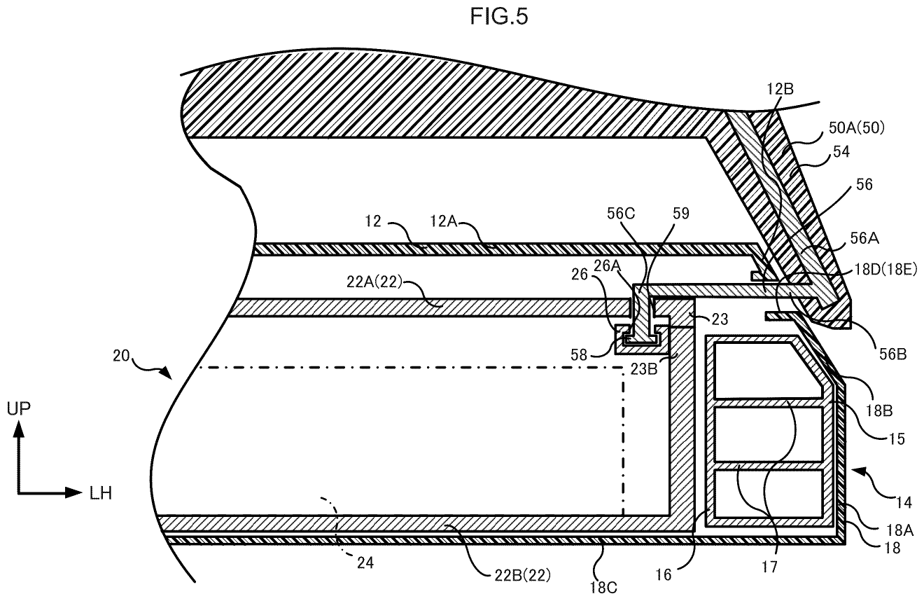

Note that in the above exemplary embodiment, the seat rail 26 at the vehicle width direction outer side is provided at a position facing the wall portion 23 of the drive battery pack 20; however, the present disclosure is not limited thereto. FIG. 4 shows a modified example corresponding to FIG. 3, and FIG. 5 shows another modified example corresponding to FIG. 3. As illustrated in FIG. 4, for example, the seat rail 26 may be provided at a side face at the outer side of the wall portion 23 of the drive battery pack 20. In such cases, the seat rail 26 is fastened to the wall portion 23 by a bolt or the like, as an example. In such cases, the same advantageous effects as in the above exemplary embodiment can be obtained.

As illustrated in FIG. 5, the seat rail 26 may be provided inside the wall portion 23B of the battery lower case 22B of the drive battery pack 20. In such cases, an insertion hole 59 through which the lower frame 56C is inserted is provided in the battery upper case 22A positioned at a vehicle upper side of the seat rail 26, and the slide member 58 is inserted through the insertion hole 59. Note that the insertion hole 59 extends in the vehicle front-rear direction.

In the vehicle lower structure 10 illustrated in the modified example, the seat rail 26 is provided inside the wall portion 23B of the drive battery pack 20. Therefore, since there is no need to provide space for newly arranging the seat rail 26 at the outside of the drive battery pack 20, an increase in the arrangement space in the vehicle width direction can be suppressed.

### Supplementary Features of the Present Embodiments

As illustrated in FIGS. 3 and 4, in the above exemplary embodiments, the concave portion 26A of the seat rail 26 is installed such that the upper side is open; however, the present disclosure is not limited thereto. For example, the concave portion 26A of the seat rail 26 may be installed so as to be open at the vehicle width direction outer side.

In the above exemplary embodiments, as an example, a seat rail, including the concave portion 26A that is engaged with the slide member 58 at the side of the inner seat leg portion 50B, is provided at an upper face of the battery upper case 22A positioned at the vehicle lower end of the opening of the floor panel 12 described above; however, the present disclosure is not limited thereto. For example, in cases in which plural drive battery packs 20 are disposed side-by-side in the vehicle width direction, the seat rail at the side of the inner seat leg portion 50B can be configured in the same manner as the seat rail 26 of the outer seat leg portion 50A.

Exemplary embodiments of the present disclosure have been described above; however, the embodiments of the present disclosure are not limited to the above exemplary embodiments, and may be implemented by appropriately combining exemplary embodiments and various modified examples, or may be practiced in various modes without departing from the spirit of the present disclosure.

What is claimed is:

1. A vehicle lower structure of an electrically-powered vehicle, the structure comprising:
a drive battery pack installed at a vehicle lower side of a floor of the vehicle; and
at least one seat rail configured engageably with a slide member provided at a vehicle seat, the seat rail being provided at the vehicle lower side of the floor, and at a wall portion in a vehicle width direction of the drive battery pack or at a position opposing the wall portion.

2. The vehicle lower structure of an electrically-powered vehicle of claim 1, further comprising a rocker provided at each of respective end parts in a vehicle width direction of the vehicle, and along a vehicle front-rear direction,
wherein the seat rail is provided at an outer side in a vehicle width direction of the vehicle seat, and is disposed at an outer side of the wall portion of the drive battery pack and at an upper face of the rocker.

3. The vehicle lower structure of an electrically-powered vehicle of claim 1, wherein the seat rail is provided at an outer side in a vehicle width direction of the vehicle seat, and is disposed at an inner side of the wall portion of the drive battery pack.

4. A vehicle seat structure, comprising:
the vehicle lower structure of claim 1;
a seat cushion configured to seat an occupant;
a pair of seat leg portions extending towards a vehicle lower side at respective vehicle width direction sides of the seat cushion, and disposed overlapping with side faces of the floor of the vehicle; and
a slide member provided at at least one seat leg portion corresponding to the seat rail among the pair of seat leg portions, and being configured to move along the seat rail.

5. The vehicle seat structure of claim 4, wherein the at least one seat leg portion is provided with the slide member at a side of a face opposing the other seat leg portion.
